(19) United States
(12) Patent Application Publication
(10) Pub. No.: US 2012/0018957 A1
(43) Pub. Date: Jan. 26, 2012

(54) SEAL RING

(75) Inventor: Koji Watanabe, Ibaraki (JP)

(73) Assignee: NOK Corporation, Tokyo (JP)

(21) Appl. No.: 13/259,515

(22) PCT Filed: Feb. 24, 2011
(86) PCT No.: PCT/JP2011/054184

§ 371 Date: Sep. 23, 2011

(30) Foreign Application Priority Data
Feb. 26, 2010 (JP) 2010-041976

(51) Int. Cl. F16J 15/34

(52) U.S. Cl. 277/387

(57) ABSTRACT

A seal ring having a more stable torque reduction effect. A seal ring is adapted to seal the annular gap between a housing and a shaft which is inserted through the shaft hole of the housing, the housing and the shaft being provided so as to be rotatable relative to each other. The seal ring is mounted in an annular groove provided in the shaft, is configured so that the seal ring is pressed, by the pressure of fluid to be sealed, against a side surface of the annular groove and against the inner peripheral surface of the shaft hole, and has a recess (14) provided in the slide region of the seal ring which slides on the side surface of the annular groove, the recess (14) being separated from the side surface of the annular groove so that a force acting against the force which presses the seal ring against the side surface of the annular groove by the effect of the pressure is generated. The recess (14) comprises: a circular arc section (14a) which extends in the circumferential direction on the inner side of the slide region; and an introduction section (14b) which, in order to introduce the fluid to be sealed to the circular arc section (14a), extends from the end of the slide region which is adjacent to a region (O) to be sealed to the end of the circular arc section (14a) which is on the upstream side of the direction of the flow of the fluid to be sealed.

### TECHNICAL FIELD

The present invention relates to a seal ring to seal annular gap between two members which are relatively rotatable to each other.

### BACKGROUND ART

In a case that annular gap between two members which are relatively rotatable to each other is sealed by a seal ring, sliding between the seal ring and the respective two members causes a problem at the time when the two members are relatively rotated. There has been known a seal ring having a groove (i.e., a recess portion) at a sliding face thereof so as to reduce torque generated by such sliding.

A seal ring according to embodiments of the related art will be described with reference to FIGS. 8A to 10C. FIGS. 8A and 8B are schematic views illustrating a structure of a seal ring according to the first embodiment of the related art. FIG. 8A is a view illustrating a part of a side face of the seal ring. FIG. 8B is a sectional view at C-C of FIG. 8A. FIGS. 9A to 9C are schematic views illustrating a structure of a seal ring according to the second embodiment of the related art. FIG. 9A is a view illustrating a part of a side face of the seal ring. FIG. 9B is a sectional view on arrow D of FIG. 9A. FIG. 9C is a sectional view at E-E of FIG. 9A. FIGS. 10A and 10B are schematic views illustrating a structure of a seal ring according to the third embodiment of the related art. FIG. 10A is a view illustrating a part of a side face of the seal ring. FIG. 10B is a sectional view at F-F of FIG. 10A.

As illustrated in FIGS. 8A and 8B, in the seal ring 100a according to the first embodiment of the related art, a groove 102a with cone-like inclination is formed at a sliding face 101 (see Patent document 1). Owing to the inclination of the groove 102a, wedge-like gap is formed between a side face 31 of an annular groove 30 of a shaft 3 and the seal ring 100a. When sealed fluid such as oil inflows to such gap, a so-called wedge effect occurs and force (P10) acting against force (P20+P30) pressing the seal ring 100a to the side face 31 is increased. Accordingly, sliding resistance between the seal ring 100a and the side face 31 is reduced.

Similarly to the first embodiment of the related art, the seal ring 100b according to the second embodiment of the related art is structured to generate the wedge effect by arranging a groove 102b with an inclined face at a sliding face 101, as illustrated in FIGS. 9A to 9C (see Patent document 2).

In the seal ring 100c of the third embodiment of the related art, a screw-like cut-out groove 102c is arranged as illustrated in FIGS. 10A and 10B (see Patent document 3). It is structured that P10 is increased with increase of pressure in gap (i.e., dynamic pressure occurrence) by inflowing of the sealed fluid to slight gap which is formed between the screw-like fine cut-out groove 102c and the side face 31.

Besides the above, a variety of structures have been proposed (see Patent documents 4 to 7).

As illustrated in FIGS. 8A to 9C, the wedge-like gap formed between the side face 31 and the groove 102a, 102b in the first and second embodiments of the related art is widely opened to an inner circumferential face 103 of the seal ring facing to a sealed area (O). Therefore, the sealed fluid easily inflows to and outflows from the gap. Accordingly, there has been a problem of frequent occurrence of a case that a desired wedge effect cannot be obtained owing to frequently-formed flow of the sealed fluid as escaping from the gap without contributing to dynamic pressure generation due to the wedge effect.

Further, as illustrated in FIGS. 10A and 10B, gap formed between the cut-out groove 102c and the side face 31 of the third embodiment of the related art is not provided with an outlet at the downstream side of the flowing direction of the sealed fluid as being structured that the entered sealed fluid hardly escapes. With this structure, the sealed fluid is easily introduced to a sliding area of the sliding face 101 in a constructive manner. However, since the length of the cut-out groove 102c is limited owing to limitation of extrusion clearance G, the amount of the sealed fluid which can be introduced is to be limited. Here, since leakage is increased if the groove 102c is communicated with a non-sealed area (A), the groove 102c cannot be extended across the extrusion clearance G.

Further, since the cut-out groove 102c is extended toward the outer circumference side of the sliding face 101, the sealed fluid flows in approximately radially outwardly direction to be introduced to the sliding area of the sliding face 101 from the top end of the groove 102c with the flow thereof. Therefore, the sealed fluid introduced to the sliding area is likely to leak to the non-sealed area (A) side from the extrusion clearance G. Accordingly, there may be a case that desired reduction of sliding resistance cannot be achieved.

### CITED DOCUMENT

### Patent Document

Patent document 1: WO2004/090390

Patent document 2: Japanese Patent Application Laid-Open No. 9-210211

Patent document 3: Japanese Utility Model Application Laid-Open No. 3-88062

Patent document 4: Japanese Patent Application Laid-Open No. 2000-310336

Patent document 5: Japanese Patent Application Laid-Open No. 2006-342889

Patent document 6: Japanese Patent Application Laid-Open No. 2008-275052

Patent document 7: Japanese Utility Model Application Laid-Open No. 5-61566

### DISCLOSURE OF THE INVENTION

### Problems to be Solved by the Invention

To address the above issues of the related art, the present invention provides a seal ring capable of stably obtaining a torque reduction effect.

### Means to Solve the Problems

In order to achieve the above object, there is provided a seal ring to seal annular gap between a housing and a shaft inserted to a shaft hole of the housing which are arranged relatively rotatable to each other as being attached to an annular groove formed at a surface of one of the housing and the shaft so as to be pressed to a side face of the annular groove and a surface of the other of the shaft hole and the shaft by pressure of sealed fluid, wherein a recess portion being apart from a side face of the annular groove is formed at a sliding area against the side face of the annular groove so as to generate force acting against pressing force to the side face of the annular groove owing to action of the pressure, and the recess portion includes an arc-shaped portion extending at the inside of the sliding area along the circumferential direction, and an introduction portion extending from an end of the sliding area being adjacent to a sealed area to an end portion of the arc-shaped portion at the upstream, side of the flowing direction of the sealed fluid so as to introduce the sealed fluid to the arc-shaped portion.

According to the present invention, force acting against force pressing the seal ring to the side face of the annular groove (i.e., force drawing the seal ring away from the annular groove side face) is generated by inflow of the sealed fluid to the gap formed between the recess portion and the side face of the annular groove.

The sealed fluid inflows to one end of the arc-shaped portion via the introduction portion which opens the gap to the sealed area and flows toward the other end of the arc-shaped portion (i.e., the opposite end portion to the end portion communicated with the introduction portion) along the arc-shaped portion circumferentially-extending at the inside of the sliding area. The other end of the arc-shaped portion terminates within the sliding area. Then, pressure in the gap is increased owing to the sealed fluid losing its way as arriving at the other end of the arc-shaped portion (i.e., dynamic pressure occurrence), so that the force drawing the seal ring away from the annular groove side face is increased. Accordingly, the sealed fluid becomes likely to be introduced to the sliding area and reduction of sliding resistance can be achieved.

The recess portion of the seal ring according to the present invention terminates as causing the sealed fluid flowed into the recess portion (i.e., the arc-shaped portion) to flow along the circumferential direction. Accordingly, the sealed fluid flowing within the recess portion becomes likely to be introduced to the sliding area from the end of the arc-shaped portion (i.e., the top end of the recess portion) with flow along the circumferential direction, so that lubricating film of the sealed fluid can be stably formed at the sliding area. That is, since the introduction to the sliding area is performed without flow toward the non-sealed area side, it is suppressed for the sealed fluid which is introduced to the sliding area to leak immediately to the non-sealed area side.

Depth of the recess portion may be decreased toward the flowing direction of the sealed fluid. Further, it is preferable that width of the arc-shaped portion is deceased toward the flowing direction of the sealed fluid.

With the above, the gap formed by the recess portion and the side face of the annular groove is structured to be narrowed as a wedge shape gradually toward the downstream of the flowing direction of the sealed fluid. Accordingly, a wedge effect occurs at the sealed fluid flowing within the recess portion, so that the force drawing the seal ring away from the annular groove side face can be stably generated.

The introduction portion may be extended from the end of the sliding area toward the end portion of the arc-shaped portion as being inclined to the flowing direction of the sealed fluid.

With the above, inflow of the sealed fluid to the introduction portion is smoothly performed, so that dynamic pressure occurrence due to the recess portion can be stabilized.

### Effects of the Invention

According to the present invention, a torque reduction effect can be stably obtained.

### BRIEF DESCRIPTION OF THE DRAWINGS

FIG. 1A is a schematic view of a seal ring according to the first embodiment of the present invention viewing from the axial direction.

FIG. 1B is a view on arrow A of FIG. 1A.

FIG. 2A is a schematic view illustrating a part of a side face of the seal ring.

FIG. 2B is a sectional view at B-B of FIG. 2A.

FIG. 3 is a schematic sectional view illustrating an attached state of the seal ring.

FIG. 4A is a sectional view of a step-shaped recess portion.

FIG. 4B is a sectional view of a curved recess portion.

FIG. 5 is a schematic view illustrating a structure of a recess portion of a seal ring according to the second embodiment of the present invention.

FIG. 6 is a schematic view illustrating structure of a recess portion of a seal ring according to the third embodiment of the present invention.

FIG. 7 is a schematic view illustrating a structure of a recess portion of a seal ring according to the fourth embodiment of the present invention.

FIG. 8A is a view illustrating a part of a side face of a seal ring according to the first embodiment of the related art.

FIG. 8B is a sectional view at C-C of FIG. 8A.

FIG. 9A is a view illustrating a part of a side face of a seal ring according to the second embodiment of the related art.

FIG. 9B is a sectional view on arrow D of FIG. 9A.

FIG. 9C is a sectional view at E-E of FIG. 9A.

FIG. 10A is a view illustrating a part of a side face of a seal ring according to the third embodiment of the related art.

FIG. 10B is a sectional view at F-F of FIG. 10A.

### MODES FOR CARRYING OUT THE INVENTION

In the following, the present invention will be described in detail with reference to the drawings based on embodiments in an exemplified manner. Here, dimensions, materials, shapes and relative arrangement thereof described in the embodiments are not intended to limit the scope of the present invention thereto unless otherwise noted.

### First Embodiment

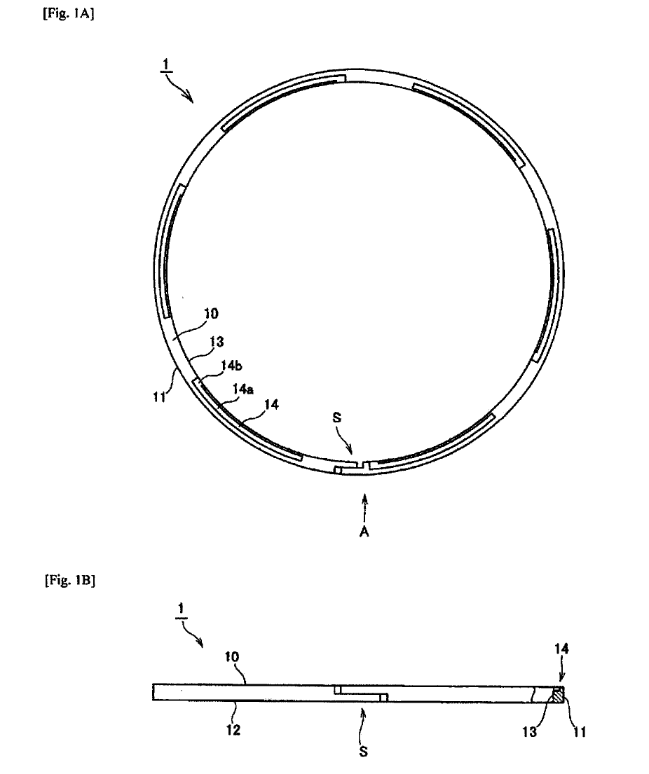

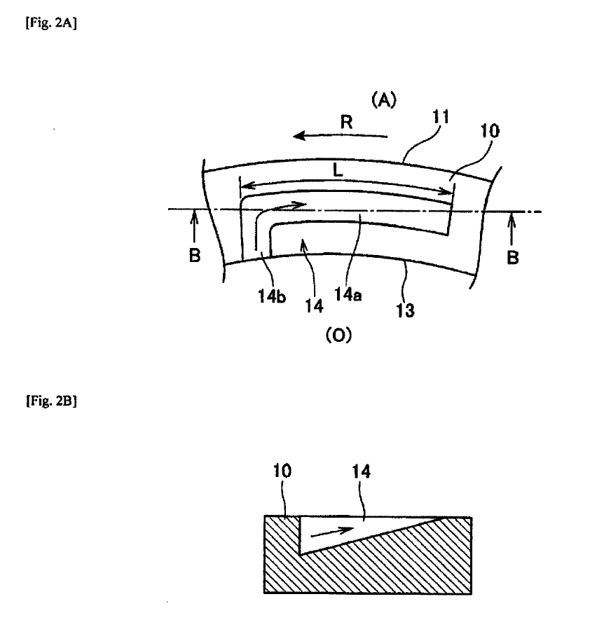

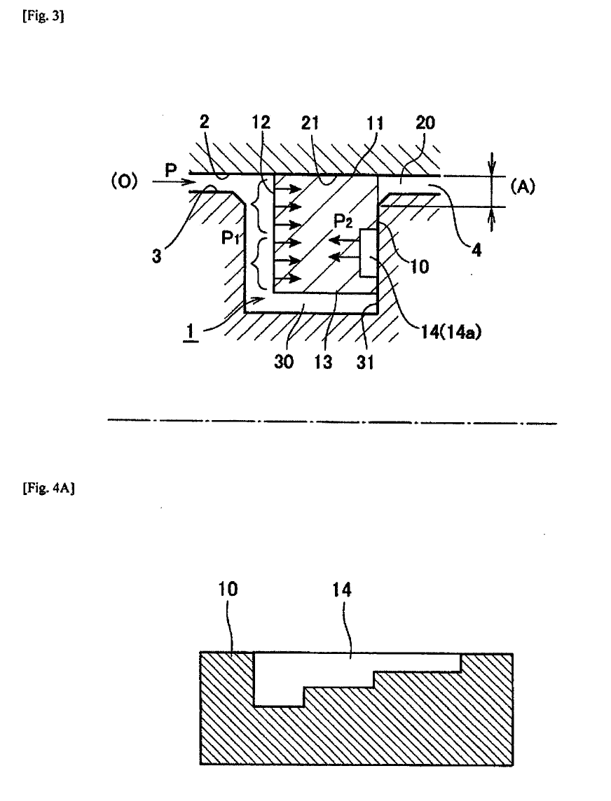

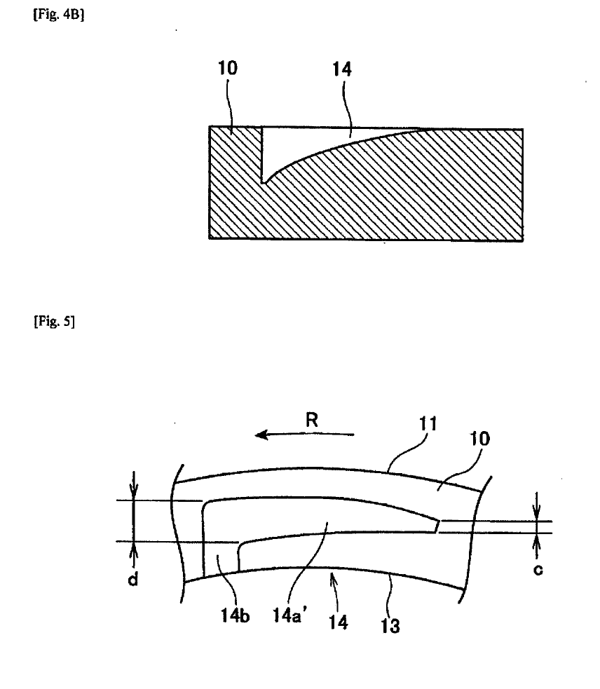

A seal ring according to the first embodiment of the present invention will be described with reference to FIGS. 1A to 4B. FIGS. 1A and 1B are schematic views illustrating an overall structure of the seal ring according to the first embodiment of the present invention. FIG. 1A is a schematic view (i.e., a plain view) viewing the seal ring from the axial direction. FIG. 1B is a view on arrow A of FIG. 1A including a partial section. FIGS. 2A and 2B are schematic views illustrating a structure of a recess portion. FIG. 2A is a schematic view illustrating a part of a side face of the seal ring. FIG. 2B is a sectional view at B-B of FIG. 2A. FIG. 3 is a schematic sectional view in a state that the seal ring according to the embodiment of the present invention is mounted. FIGS. 4A and 4B are schematic sectional views illustrating a structure of a modification of a recess portion. FIG. 4A is a sectional view of a step-shaped recess portion and FIG. 4B is a sectional view of a curved recess portion.

### <General Structure of Seal Ring>

As illustrated in FIGS. 1A and 1B, a seal ring 1 being an annular member provided with a separated portion S at one position on the circumference thereof is formed of resin material such as polytetrafluoroethylene (PTFE) and polyether ether ketone (PEEK).

As illustrated in FIG. 3, the seal ring 1 seals annular gap 4 between a shaft hole 20 of a housing 2 and a shaft 3 to be inserted to the shaft hole 20. The seal ring 1 is a seal ring of which section is approximately rectangular having side faces 10, 12 which are perpendicular to the shaft and an outer circumferential face 11 and an inner circumferential face 13 which are parallel to the shaft. The seal ring 1 is attached to an annular groove 30 which is formed at an outer circumferential face of the shaft 3. The side face 10 at a non-sealed area side (A) is intimately contacted to a side face 31 of the annular groove 30 and the outer circumferential face 11 is intimately contacted to an inner circumferential face 21 of the shaft hole 20 by action of pressure P at a sealed area side (O). Further, when relative rotation occurs between the housing 2 and the shaft 3, the side face 10 slides against the side face 31 of the annular groove 30. Accordingly, the sealed fluid existing at the sealed area side (O) is prevented from leaking to the non-sealed side (A). Here, for example, the sealed fluid is lubricant oil, and in particular, is automatic transmission fluid (ATF) in a case of automatic transmission of automobiles.

As illustrated in FIGS. 2A and 2B, the seal ring 1 according to the present embodiment is provided with a recess portion 14 at the side face 10 which is a sliding face against the side face 31 of the annular groove 30. The recess portion 14 is arranged at a sliding area of the side face 10 against the side face 31. Since a part of the sliding area is apart from the side face 31 owing to the recess portion 14, it is structured to generate force P2 acting against pressing force P1 to the side face 31 owing to action of pressure P (i.e., force P2 drawing the seal ring 1 away from the side face 31) while sliding area is reduced.

As illustrated in FIGS. 1A and 1B, the seal ring 1 according to the present embodiment adopts a traditionally-known step-cut shape as the separated portion S. That is, it is structured that a convex portion arranged at one end portion of the seal ring and a convex portion arranged at the other end portion are to be associated at the separated portion S. The separated portion S is connected owing to fitting between the convex portion and a concave portion, so that the annular-shaped seal ring 1 is formed. Since a side face of the convex portion and a side face of the concave portion are contacted, sliding seal faces are formed as being slidable in the circumferential direction at the fitting portion of the separated portion S. Further, a gap capable of absorbing circumferential length variation of the seal ring 1 is formed between a top end face of the convex portion and a bottom face of the concave portion. Here, not limited to the above, the separated portion S may be formed in various shapes of the related art.

### <Structure of Recess Portion>

As illustrated in FIG. 2A, the recess portion 14 being an approximately L-shaped groove includes an arc-shaped portion 14a which extends along the circumferential direction and an introduction portion 14b which is also opened to the inner circumferential face 13 as extending to a boundary with the inner circumferential face 13 of the sliding area from one end of the arc-shaped portion 14a. Arc length L of the arc-shaped portion 14a is set in a range between 10° and 170° against circumferential length 360° of the seal ring 1 in consideration of the length for obtaining a desired dynamic pressure generating effect, the length of the separated portion S and the like. A plurality of the recess portions 14 are arranged as being aligned along the circumferential direction of the side face 10 as illustrated in FIG. 1A.

With the above recess portions 14, gap opened to the sealed area (O) is formed between the seal ring 1 and the side face 31 at the sliding area of the side face 10. The sealed fluid flows in the opposite direction to the rotational direction (indicated by arrow R) of the seal ring 1 owing to relative rotation between the housing 2 and the shaft 3. The introduction portion 14b is communicated with an end part of the arc-shaped portion 14a at the upstream side in the flowing direction of the sealed fluid. The sealed fluid inflows from the introduction portion 14b and flows within the arc-shaped portion 14a in the circumferential direction.

As illustrated in FIG. 2B, the recess portion 14 (i.e., the arc-shaped portion 14a) is structured that the depth thereof is to be decreased toward the flowing direction of the sealed fluid. Accordingly, the gap between the recess portion 14 and the side face 31 is formed to be narrowed as a wedge shape gradually toward the downstream of the flowing direction of the sealed fluid.

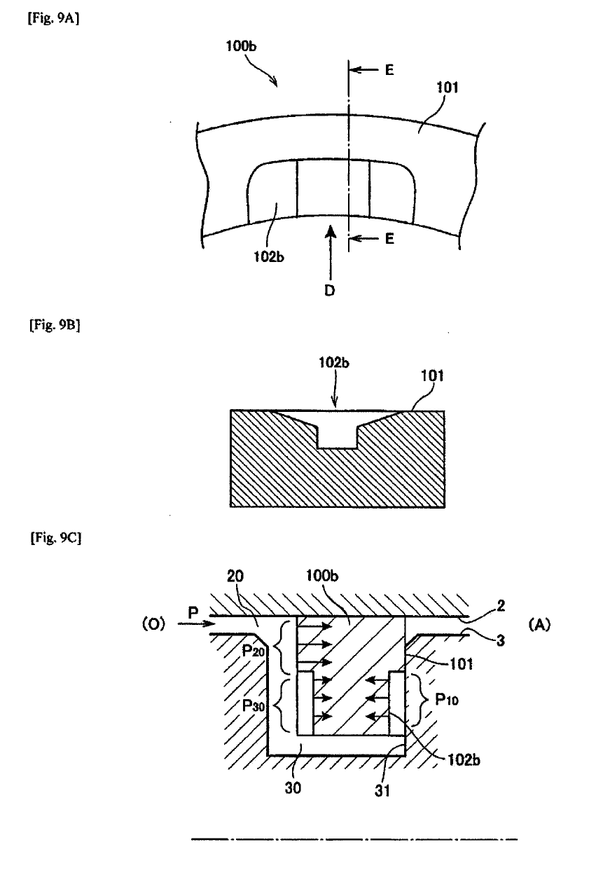

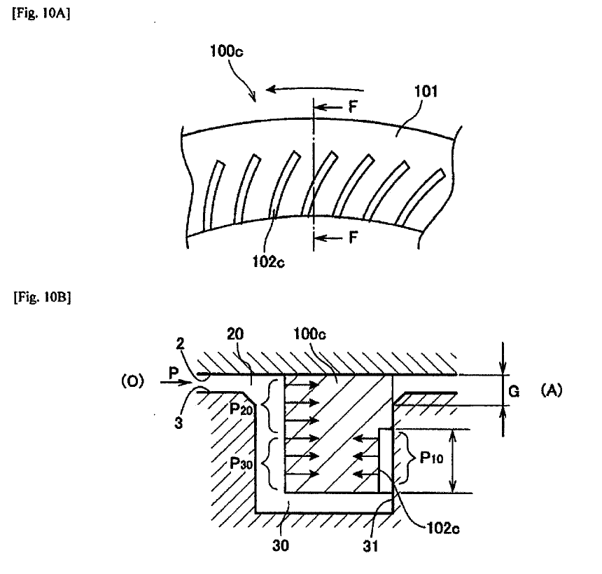

Here, as in modifications illustrated in FIGS. 4A and 4B, depth variation of the recess portion 14 (i.e., the arc-shaped portion 14a) can be actualized variously. That is, as illustrated in FIG. 9A, it is also possible to adopt a step-shaped bottom face of which depth is varied stepwise. Further, as illustrated in FIG. 4B, it is also possible to adopt a curved bottom face of which depth is varied in a curved manner. Furthermore, it is also possible to vary depth by combining a plurality of faces of which inclination angles are different (not illustrated).

### Advantages of the Present Embodiment

A part of the sealed fluid flowing within the sealed area (O) inflows to the gap formed between the recess portion 19 and the side face 31 via the introduction portion 14b which is opened to the inner circumferential face 13. The sealed fluid flows from one end of the circumferentially-extending arc-shaped portion 14a to the other end along the circumferential direction. The other end of the arc-shaped portion 14a (i.e., the end portion at the downstream side of the flowing direction of the sealed fluid) terminates at the inside of the sliding area of the side face 10. Then, pressure in the gap is increased owing to the sealed fluid losing its way as arriving at the other end of the arc-shaped portion 14a (i.e., dynamic pressure occurrence), so that the force P2 drawing the seal ring 1 away from the annular groove side face 31 is increased. Accordingly, a lubricating film of the sealed fluid is formed between the side face 10 of the seal ring 1 and the side face 31 of the annular groove 30 as the sealed fluid being introduced to the sliding area, so that sliding resistance can be reduced.

The recess portion 14 terminates as causing the sealed fluid flowed into the recess portion 14 (i.e., the arc-shaped portion 14a) to flow along the circumferential direction. Accordingly, the sealed fluid flowing within the recess portion 14 becomes likely to be introduced to the sliding area from the end of the arc-shaped portion 14a with flow along the circumferential direction, so that the lubricating film of the sealed fluid can be stably formed at the sliding area. That is, since the introduction to the sliding area is performed without flow toward the non-sealed area (A) side, it is suppressed for the sealed fluid which is introduced to the sliding area to leak immediately to the non-sealed area (A) side.

Further, the gap formed between the recess portion 14 and the side face 31 is structured to be narrowed as a wedge shape gradually toward the downstream of the flowing direction of the sealed fluid. Accordingly, a wedge effect occurs at the sealed fluid flowing within the recess portion 14 (i.e., the arc-shaped portion 14b), so that the force P2 drawing the seal ring 1 away from the annular groove side face 31 can be stably generated.

In this manner, according to the present embodiment, it is possible to stably obtain a torque reduction effect. Further, owing to stabilization of the torque reduction effect, it becomes possible to stably obtain a suppression effect of sliding heat generation. Accordingly, it becomes possible to be used under higher PV conditions. Furthermore, owing to stable forming of the lubricating film of the sealed fluid, light and soft material can be utilized as the material for the shaft and housing as being capable of contributing to lightening of an applicable apparatus.

### Second Embodiment

A seal ring according to the second embodiment of the present invention will be described with reference to FIG. 5. FIG. 5 is a schematic view illustrating a structure of a recess portion of the seal ring according to the second embodiment. Here, description will be made only on points being different from the first embodiment and description of the common structure will not be repeated.

As illustrated in FIG. 5, the seal ring according to the second embodiment is structured that width of an arc-shaped portion 14a′ is decreased toward the flowing direction of the sealed fluid. That is, the arc-shaped portion 14a′ is formed so that radial width d at one end side being an inlet thereof is wide and that radial width c at the other end side is narrow. With this structure, the wedge effect (i.e., dynamic pressure) becomes likely to occur owing to the sealed fluid flowing within the recess portion 14 (i.e., the arc-shaped portion 14b), so that the force P2 drawing the seal ring 1 away from the annular groove side face 31 can be stably generated. Further, since the flow of the sealed fluid is concentered toward the end of the arc-shaped portion 14a′, introducing of the sealed fluid to the sliding area and forming of the lubricating film are promoted at the vicinity of the end of the arc-shaped portion 14a′.

### Third Embodiment

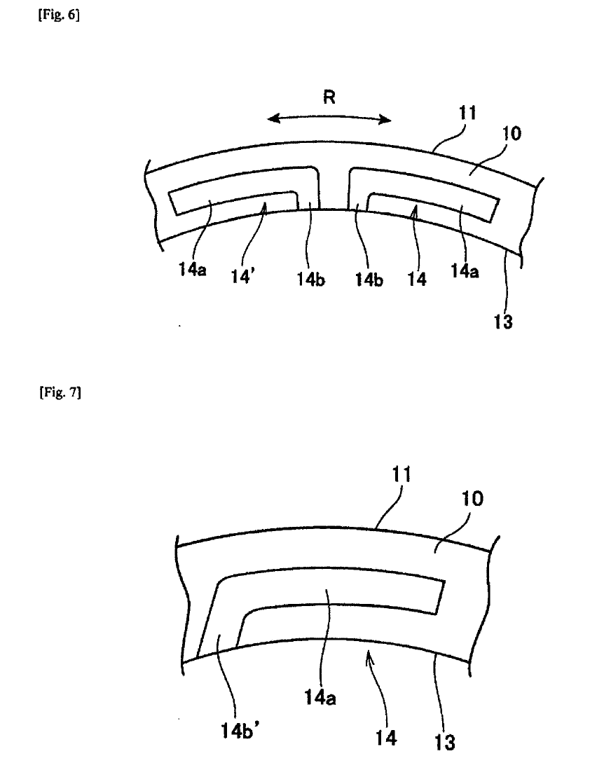

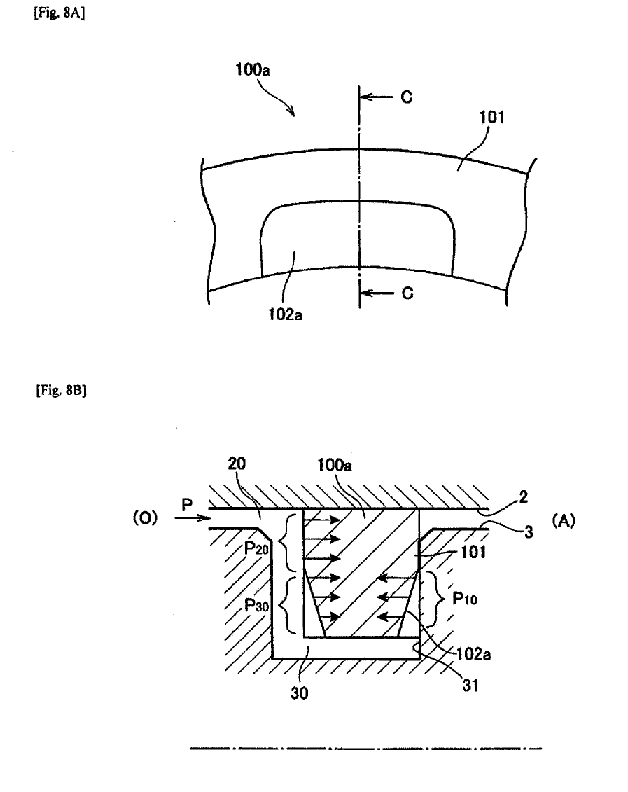

A seal ring according to the third embodiment of the present invention will be described with reference to FIG. 6. FIG. 6 is a schematic view illustrating a structure of a recess portion of the seal ring according to the third embodiment. Here, description will be made only on points being different from the above embodiments and description of the common structure will not be repeated.

As illustrated in FIG. 6, the seal ring according to the third embodiment is provided with a second recess portion 14′ which is structured circumferentially symmetric to a first recess portion 14. Location of the introduction portion 14b of the second recess portion 14′ is different from that of the first recess portion 14. Further, variation of groove depth thereof is symmetric to that of the first recess portion 14 as being reversed thereto. That is, the second recess portion 14′ is configured to generate dynamic pressure (i.e., the wedge effect) in a case when the flowing direction of the sealed fluid is opposite to the case of the first recess portion 14. Therefore, according to the seal ring of the present embodiment, it is possible to obtain the dynamic pressure generating effect due to the recess port ion in either direction of the relative rotation between the housing 2 and the shaft 3.

### Fourth Embodiment

A seal ring according to the fourth embodiment of the present invention will be described with reference to FIG. 7. FIG. 7 is a schematic view illustrating a structure of a recess portion of the seal ring according to the fourth embodiment. Here, description will be made only on points being different from the above embodiments and description of the common structure will not be repeated.

As illustrated in FIG. 7, in the seal ring according to the fourth embodiment, an introduction portion 14b′ of the recess portion 14 is formed to extend toward the end portion of the arc-shaped portion 14a from an end of the sliding area as being inclined to the flowing direction of the sealed fluid. With this structure, inflow of the sealed fluid to the introduction portion 14b′ is smoothly performed, so that dynamic pressure (i.e., the wedge effect) due to the recess portion 14 can be further stably generated.

### (Other)

In the description of the above embodiments, the seal ring 1 is configured to be attached to the annular groove 30 which is formed at the outer circumferential face of the shaft 3. However, it is also possible that the seal ring 1 is attached to an annular groove which is formed at the inner circumferential face 21 of the shaft hole 20 of the housing 2 and to seal the annular gap 4 as being slid against the outer circumferential face of the shaft 3.

In addition, the above embodiments can be respectively combined as much as possible.

### DESCRIPTION OF REFERENCE NUMERALS

1 Seal ring
10 Side face (Sliding face)
11 Outer circumferential face
12 Side face
13 Inner circumferential face
14 Recess portion
14a Arc-shaped portion
14b Introduction portion
2 Housing
20 Shaft hole
21 Inner circumferential face
3 Shaft
30 Annular groove
31 Side face
4 Annular gap

1. A seal ring to seal annular gap between a housing and a shaft inserted to a shaft hole of the housing which are arranged relatively rotatable to each other as being attached to an annular groove formed at a surface of one of the housing and the shaft so as to be pressed to a side face of the annular groove and a surface of the other of the shaft hole and the shaft by pressure of sealed fluid,
wherein a recess portion being apart from a side face of the annular groove is formed at a sliding area against the side face of the annular groove so as to generate force acting against pressing force to the side face of the annular groove owing to action of the pressure, and
the recess portion includes an arc-shaped portion extending at the inside of the sliding area along the circumferential direction, and an introduction portion extending from an end of the sliding area being adjacent to a sealed area to an end portion of the arc-shaped portion at the upstream side of the flowing direction of the sealed fluid so as to introduce the sealed fluid to the arc-shaped portion.

2. The sealing ring according to claim 1,
wherein depth of the recess portion is decreased toward the flowing direction of the sealed fluid.

3. The seal ring according to claim 1,
wherein width of the arc-shaped portion is decreased toward the flowing direction of the sealed fluid.

4. The sealing ring according to claim 1,
wherein the introduction portion is extended from the end of the sliding area toward the end portion of the arc-shaped portion as being inclined to the flowing direction of the sealed fluid.
